(19) United States
(12) Patent Application Publication
(10) Pub. No.: US 2008/0294530 A1
(43) Pub. Date: Nov. 27, 2008

(54) System and method for registering the ownership and exchange of an item

(76) Inventors: William Michael Ritsch, Cartersville, GA (US); Rebecca Yvonne Graham, Cartersville, GA (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 12/011,927

(22) Filed: Jan. 30, 2008

Related U.S. Application Data
(60) Provisional application No. 60/898,443, filed on Jan. 30, 2007.

(51) Int. Cl. G06Q 30/00; G06Q 20/00

(52) U.S. Cl. 705/26

(57) ABSTRACT

A system and method for promoting the exchanging of an article between individuals, registering the ownership and exchange of the article via a global central registry, and wherein such article of trade has a unique identifier affixed thereto that functions to identify such article and enable a user of the registry to update and track the current and historical ownership and travels of such article via the internet.

### RELATED APPLICATIONS

The present Nonprovisional Application is related to, and hereby claims priority to and the benefit of, U.S. Provisional Application No. 60/898,443, entitled “System and Method for Registering the Ownership and Exchange of an Item,” filed on Jan. 30, 2007.

### COPYRIGHT NOTICE

A portion of the disclosure of this patent document contains material which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### FIELD OF THE INVENTION

The present invention relates generally to communications for registering items and more specifically to a method, system and apparatus for registering the ownership and exchange of an item or object, such as jewelry.

### BACKGROUND OF THE INVENTION

All human beings are connected in some way, whether it is through business, entertainment, education, athletics, social affairs, family, geography, residence or the like. Our differences derive from our religious beliefs, political views, economic status, genetics, gender, and customs, which cover a wide spectrum of possibilities. Lugi Luca Cavalli-Sforza, a geneticist, proposed in the 1950s that our blood would one day reunite humanity with its ancestors. Building on that theory, genetic scientists in the 1990s traced our ancestors back 50,000 years through genetic markers in the y-chromosome found in the blood of males. Moreover, a recent theory has been proposed that there is at most only six degrees of separation between any two individuals, meaning there is a tight connection or link between all of us.

Historically, human beings, whether from different villages or countries, have maintained friendly relationships with their neighbors through their interactions while conducting trade. Desire to maintain access to items available only through trading with neighbors enabled trading partners to look beyond differences in personal beliefs, pride, values and prejudices. In spite of such differences, each of us adhere to common themes and beliefs that transcend those differences, including hope for the safety and health of family and loved ones, especially when experiencing the hardships of illness or death, the joy of child birth, a desire to make life better for children, and taking pride in setting out to achieve a goal and relish in its accomplishment, to name a few.

Moreover, trade of commercial items between individuals is a personal experience that tends to bring people closer together by educating both sides on the customs, struggles, similarities and unique attributes of both parties engaging in the transaction. Moreover, articles of trade can take on many forms, whether essential, rare, unique, personal, or common goods are being offered for exchange. For example, some types of personal articles of trade identify an individual's affiliations, status, personality, likes, dislikes, or even advertise causes for which they are involved.

Given this diversity, a number of different systems and processes have been developed for tracking, identifying, authenticating and for registering articles of trade, documents or living things according to unique features found on the articles or added to the articles. For example, one such method used to identify articles is to label the items with the name and address of the owner. This method has the disadvantage, however, that the address of the owner may change and the labels will therefore become incorrect. To avoid this obsolescence, the labels must be updated each time the owner of the items changes his or her address. Such an operation is inconvenient and time consuming. Further, such updating is difficult to achieve and may be awkward where the labels are lost or difficult to place on the item, and some labels are difficult to apply to certain surfaces or may become illegible if damaged.

Other systems use a unique identifier and a database that matches the unique identifier to the article, wherein such systems have the added capability of storing additional information in association with the article. Such unique identifiers include bar code labels, unique product codes, RFID tags, holograms, micro-label, micro-engraving, laser inscription, optical codes, digital codes, and the like, which may be used to track, identify, and authenticate articles exchanged in trade.

In view of the booming e-commerce that has developed on the Internet, as well as the availability of communication in multi-media forms between individuals spread across the globe thru email and websites, individuals are enabled to communicate and trade over greater distances; thus, enabling commercial and personal relationships to exist over greater distances. In addition, such communication systems enable and facilitate the tracking, identifying, authenticating and registering of articles of trade exchanged between such individuals over such distances.

Therefore, it is readily apparent that there is a need for a system and method for registering the ownership and exchange of an article of trade to bring individuals closer together and transcend their differences, wherein the article of trade has a unique identifier that functions to identify the article and to educate individuals of the unique journey the article has taken, including information regarding previous owners, thereby enabling such owners and previous owners to communicate and share personal experiences with each other, thereby bringing individuals from across the globe closer together.

### BRIEF SUMMARY OF THE INVENTION

Briefly described, in a preferred embodiment, the present invention overcomes the above-mentioned disadvantage, and meets the recognized need for such an invention by providing a system and method for promoting the exchanging of an article between individuals by registering the ownership and exchange of the article via a global central registry, wherein such article of trade has a unique identifier affixed thereto that functions to identify the article and to enable a user of the registry to update and track the current and historical ownership and the travels of such article via the Internet, thereby enabling such individuals to communicate and share personal experiences with each other in relation to their common connection with the article, thereby, bringing individuals from across the globe closer together.

According to its major aspects and broadly stated, the present invention in its preferred form is a system and method for registering the ownership and exchange of an item or object, comprising, in general, a central server system connected to database storage device, a remote user station connected via the Internet to the central server for performing registration of an article of trade, performing registration of a new owner of the article, and identifying the historical journey and prior owners of the article registered. The system is utilized to enroll a user for registration of an article. The system requires proof of identification relative to the registered user, and requires completion of a registration template with fill-in the blank and user-selected criteria for identifying the user and for linking the user to the unique article.

More specifically, the preferred embodiment of the present invention further comprises a bracelet designed to promote and encourage use of the described exchange system where the bracelet has individual links preferably as detachable components from a base link, wherein such detachable components can be exchanged with other individuals and releasably attached to an open base link in the bracelet of another. Each detachable component preferably is releasably attached to the base link and includes an identifying insignia for unique self-identification.

Accordingly, a feature and advantage of the present invention is its ability to identify, register, and store information relating to the unique identifying insignia that identifies each detachable component of a unique bracelet wherein such information is subsequently retrievable by past, present, and/or future owners.

Accordingly, a feature and advantage of the present invention is its ability to store identifying information about each owner of the detachable component.

Another feature and advantage of the present invention is its ability to provide an improved method and system for identifying personal possessions.

Still another feature and advantage of the present invention is its ability to affix an alpha-numeric code which is unique to each detachable component.

Yet another feature and advantage of the present invention is its ability to micro-engrave an alpha-numeric code which is unique to each detachable component.

Yet another feature and advantage of the present invention is its ability to provide an insignia on the bracelet that informs others that the individual wearing the bracelet is participating in the detachable component exchange described herein.

Yet another feature and advantage of the present invention is its ability to provide a detachable component, wherein the first original owner of the detachable component is able to personalize the detachable component, such as by engraving an insignia thereon.

Yet another feature and advantage of the present invention is its ability to provide an Internet accessible database having registration capabilities and stored owner identification, detachable component and other information relating to the owners of the detachable component.

Yet another feature and advantage of the present invention is its ability to store information in an Internet-accessible database related to the detachable component and its owners past, present, and future.

Yet another feature and advantage of the present invention is its ability to provide a registration procedure for multiple owners of the detachable component thus allowing for tracking of the location and ownership history each detachable component.

Yet another feature and advantage of the present invention is its ability to provide a visible unique identifying insignia enabling an owner to input the identifying code into Internet-accessible database in order to retrieve the location and ownership history of the identified detachable component.

Yet another feature and advantage of the present invention is its ability to provide a website having a database where detachable components are registered by owners.

Yet another feature and advantage of the present invention is its ability to provide access to a database of owner information based upon entry of a unique identifying insignia, wherein such access is limited via knowledge of said unique identifying insignia.

Yet another feature and advantage of the present invention is its ability to store the unique identifying insignia and inscription for a selected component in a database, wherein such database is accessible online.

Yet another feature and advantage of the present invention is its ability to provide a worldwide, fully automated database for the immediate use and benefit of those exchanging detachable components enabling such individuals to communicate and share personal experiences with each other, thereby, bringing individuals from across the globe closer together.

Yet another feature and advantage of the present invention is its ability to provide a server and database operable to interact with a designer of detachable components to obtain unique identifying insignia information from a repository of available codes for producing additional authorized detachable components.

Yet another feature and advantage of the present invention is its ability to provide each user account with a user name and password to control access to the server and database.

Yet another feature and advantage of the present invention is its ability to provide an actual or ghosted email account, and city and country information of the original owner of the detachable component and each owner or possessor thereafter.

Yet another feature and advantage of the present invention is its ability to provide a means for a new subsequent owner and the first original owner of the detachable component to make contact and communicate with each other.

Yet another feature and advantage of the present invention is its ability to track and store the number of trades and distances traveled for each detachable component.

Yet another feature and advantage of the present invention is its ability to enable participants to dedicate a percentage of the proceeds to charitable organizations.

Yet another feature and advantage of the present invention is its ability to cast the detachable component and engrave a unique serial number on each piece.

Yet another feature and advantage of the present invention is its ability to license the detachable component design and its attachment means to other designers.

Yet another feature and advantage of the present invention is its ability to award the owners of a detachable component that has traveled the greatest distance from first original owner, or that has realized the greatest number of exchanges over a specified duration.

Yet another feature and advantage of the present invention is its ability to utilize one or more means of identifying the detachable component.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a block diagram of a computer system of the present invention;

FIG. 2 is a block diagram of a communications system implemented by the computer system in FIG. 1;

FIG. 3 is a flow diagram of a communication method, according to the preferred embodiment of the present invention, implemented via the communications system in FIG. 2;

FIG. 4 is a screen shot exemplar of a user interface of the communication method of FIG. 3 according to the preferred embodiment of the present invention;

FIG. 5 is a perspective side view of a bracelet link, according to the preferred embodiment of the present invention, showing the bracelet and component in an open, unattached configuration; and

FIG. 6 is a top view of a base component of the bracelet link according to the preferred embodiment of the present invention, showing a component insignia One World and a picture of a globe.

### DETAILED DESCRIPTION OF THE INVENTION

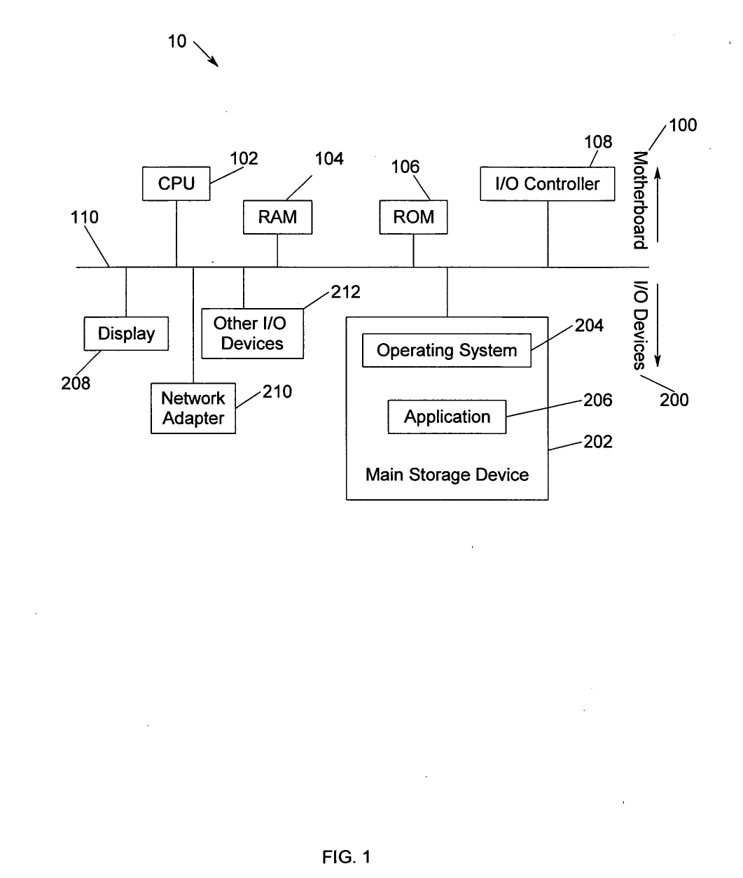

In describing the preferred and alternate embodiments of the present invention, as illustrated in FIGS. 1-6, specific terminology is employed for the sake of clarity. The present invention, however, is not intended to be limited to the specific terminology so selected, and it is to be understood that each specific element includes all technical equivalents that operate in a similar manner to accomplish similar functions.

As will be appreciated by one of skill in the art, the present invention may be embodied as a method, data processing system, or computer program product. Accordingly, the present invention may take the form of an entirely hardware embodiment, entirely software embodiment or an embodiment combining software and hardware aspects. Furthermore, the present invention may take the form of a computer program product on a computer-readable storage medium having computer-readable program code means embodied in the medium. Any suitable computer readable medium may be utilized including hard disks, ROM, RAM, CD-ROMs, electrical, optical or magnetic storage devices. Further, the system and method of the present invention may incorporate the preferred bracelet, as described herein, or may be directed for application to an alternative exchangeable item or items.

The present invention is described below with reference to flowchart illustrations of methods, apparatus (systems) and computer program products according to embodiments of the present invention. It will be understood that each block or step of the flowchart illustrations, and combinations of blocks or steps in the flowchart illustrations, can be implemented by computer program instructions. These computer program instructions may be loaded onto a general purpose computer, special purpose computer, or other programmable data processing apparatus to produce a machine, such that the instructions, which execute on the computer or other programmable data processing apparatus create means for implementing the functions specified in the flowchart block or blocks/step or steps.

These computer program instructions may also be stored in a computer-usable memory that can direct a computer or other programmable data processing apparatus to function in a particular manner, such that the instructions stored in the computer-usable memory produce an article of manufacture including instruction means which implement the function specified in the flowchart block or blocks/step or steps. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks/step or steps.

Accordingly, blocks or steps of the flowchart illustrations support combinations of means for performing the specified functions, combinations of steps for performing the specified functions and program instruction means for performing the specified functions. It should also be understood that each block or step of the flowchart illustrations, and combinations of blocks or steps in the flowchart illustrations, can be implemented by special purpose hardware-based computer systems, which perform the specified functions or steps, or combinations of special purpose hardware and computer instructions.

Computer programming for implementing the present invention may be written in various programming languages, such as conventional C calling, database languages such as Oracle or NET. However, it is understood that other source or object oriented programming languages, and other conventional programming language may be utilized without departing from the spirit and intent of the present invention.

Referring now to FIG. 1-6, the present invention in its preferred embodiment is a method, system and apparatus for promoting the exchanging of an article between individuals, and registering the ownership and exchange of the article via a global central registry, wherein such article of trade has a unique identifier affixed thereto that functions to identify the article and enable a user of the registry to update and track the current and historical ownership and travels of such article via the Internet, enabling such individuals to communicate and share personal experiences with each other in relation to their common connection with the article, thereby, bringing individuals from across the globe closer together. The system is utilized to register a user for registration of an object.

The system responds to a request from a registered user to register the object by confirmation of identification to be associated with the object. For brevity, several elements in the figures described below are represented as monolithic entities. However, as would be understood by one skilled in the art, these elements each may include numerous interconnected computers and/or components designed to perform a set of specified operations and/or dedicated to a particular geographical region.

Referring now to FIG. 1, there is illustrated a block diagram of a computer system 10 that provides a suitable environment for implementing embodiments of the present invention. The computer architecture shown in FIG. 1 is divided into two parts—motherboard 100 and the input/output (I/O) devices 200. Motherboard 100 preferably includes subsystems such as central processing unit (CPU) 102, random access memory (RAM) 104, input/output (I/O) controller 108, and read-only memory (ROM) 106, also known as firmware, which are interconnected by bus 110. A basic input output system (BIOS) containing the basic routines that help to transfer information between elements within the subsystems of the computer is preferably stored in ROM 106, or operably disposed in RAM 104. Computer system 10 further preferably includes I/O devices 200, such as main storage device 202 for storing an operating system 204 and application program(s) 206 and display 208 for visual output, respectively. Main storage device 202 preferably is connected to CPU 102 through a main storage controller (represented as 108) connected to bus 110. Network adapter 210 allows the computer system to send and receive data through communication devices. One example of a communications device is a modem including both cable and digital subscriber line (DSL). Other examples include a transceiver, a set-top box, a communication card, a satellite dish, an antenna, or any other network adapter capable of transmitting and receiving data over a communications link that is either a wired, optical, or wireless data pathway.

Many other devices or subsystems 212 may be connected in a similar manner, including but not limited to, devices such as microphone, speakers, sound card, keyboard, pointing device (e.g., a mouse), floppy disk, CD-ROM player, DVD player, printer and/or modem each connected via an I/O adapter. Also, although preferred, it is not necessary for all of the devices shown in FIG. 1 to be present to practice the present invention, as discussed below. Furthermore, the devices and subsystems may be interconnected in different configurations from that shown in FIG. 1, or may be based on optical or biological processors or gate arrays, or some combination of these elements that is capable of responding to and executing instructions. The operation of a computer system such as that shown in FIG. 1 is readily known in the art and is not discussed in further detail in this application, so as not to overcomplicate the present discussion.

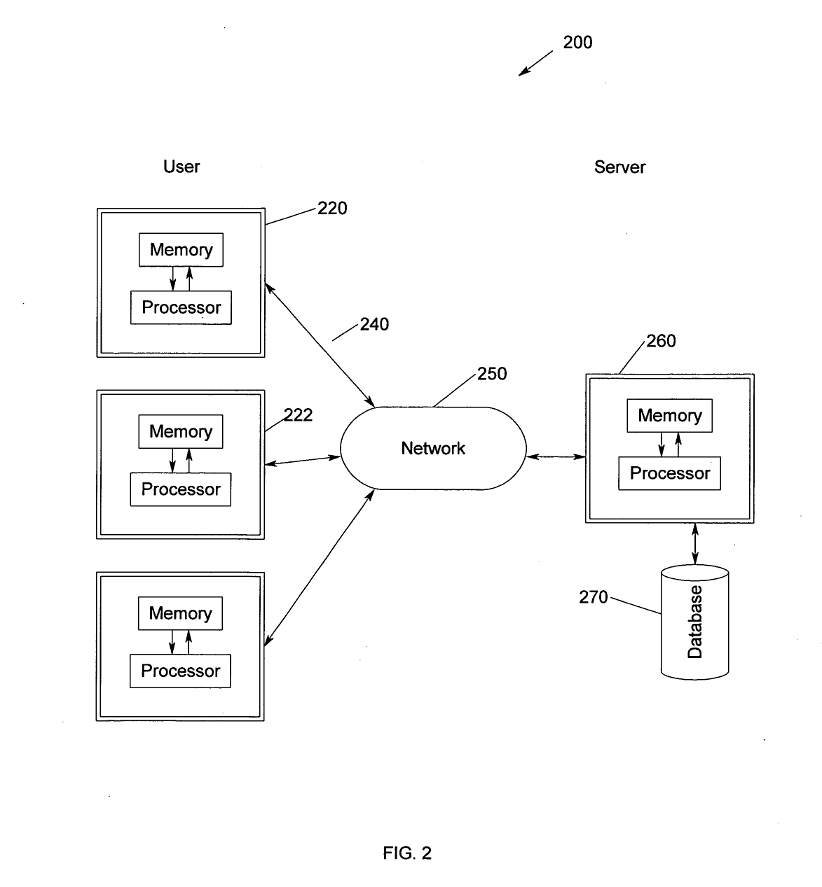

Referring now to FIG. 2, there is illustrated a diagram depicting an exemplary system in which concepts consistent with the present invention may be implemented. Examples of each element within the communication system of FIG. 2 are broadly described above with respect to FIG. 1. In particular, the server system 260 and user system 220 have attributes similar to computer system 10 of FIG. 1 and illustrate one possible implementation of computer system 10. Communication system 200 preferably includes one or more user systems 220, one or more server devices 260, and network 250, which could be, for example, the Internet. User systems 220 each preferably include a computer-readable medium, such as random access memory, coupled to a processor. The processor executes program instructions stored in memory. User system 220 may also include a number of additional external or internal devices, such as, without limitation, a mouse, a CD-ROM, a keyboard, a display, a storage device and other attributes similar to computer system 10 of FIG. 1. The communications system 200 typically includes one or more user system 220. For example, user system 220 may include one or more general-purpose computers (e.g., personal computers), one or more special purpose computers (e.g., devices specifically programmed to communicate with each other and/or the server system 260), a workstation, a server, a device, a digital assistant or a “smart” cellular telephone or pager, a component, other equipment, or some combination of these elements that is capable of responding to and executing instructions.

Similar to user system 220, server system 260 preferably includes a computer-readable medium, such as random access memory, coupled to a processor. The processor executes program instructions stored in memory. Server system 260 may also include a number of additional external or internal devices, such as, without limitation, a mouse, a CD-ROM, a keyboard, a display, a storage device and other attributes similar to computer system 10 of FIG. 1. Server system 260 may additionally include a secondary storage element, such as database 270 for storage of data and information. Server system 260, although depicted as a single computer system, may be implemented as a network of computer processors. Memory in server system 260 contains one or more application program(s) 206 (shown in FIG. 1). For example, the server system 260 may include one or more general-purpose computers (e.g., personal computers), one or more special purpose computers (e.g., devices specifically programmed to communicate with each other) a workstation or other equipment, or some combination of these elements that is capable of responding to and executing instructions.

Communications system 200 is capable of delivering and exchanging data between user system 220 and a server system 260 through communication links 240 and/or network 250. Through user system 220, users can preferably communicate over network 250 with each other and with other systems and devices coupled to network 250, such as server system 260. Communications link 240 typically includes a delivery network 250 making a direct or indirect communication between the user system 220 and the server system 260, irrespective of physical separation. Examples of a network 250 include the Internet, the World Wide Web, WANs, LANs, analog or digital wired and wireless telephone networks (e.g. PSTN, ISDN, or XDSL), radio, television, cable, satellite, and/or any other delivery mechanism for carrying and/or transmitting data or other information. The communications link 240 may include, for example, a wired, wireless, cable, optical or satellite communication system or pathway.

Application program 206 (shown in FIG. 1) preferably includes a search engine, which locates relevant information in response to search queries from user system 220. In particular, a user operating user system 220 preferably sends search queries or information requests to server system 260, wherein server system 260 and its application programs respond by returning the sought information to the user at user system 220. Preferably, user system 220 queries server system 260 to locate information relating to the exchanging of an article (preferably detachable components from a bracelet link having a unique identifier affixed thereto that functions to identify such detachable component) between individuals or users of user system 220. Moreover, users of user system 220 preferably register their ownership and exchanges of the article via a global central registry operated from server system 260, and enable a user from user system 220 to update and track the current and historical ownership and journey of such article via queries to server system 260 from user system 220. Communications system 200 preferably enables users and owners of an article to communicate via user system 220 and server system 260, and share their personal experiences with each other in relation to their common connection with the article. Further, communications system 200 preferably provides users of user system 220 a registration template with fill-in the blank and user selected criteria for identifying the user and linking the user to their unique article.

In general, processes for indexing records and searching an indexed body of records to return a set of records containing the searched terms are well known in the art, wherein any suitable indexing process maybe utilized in support of the functionality of the present invention and relative to the bracelet components registered therein.

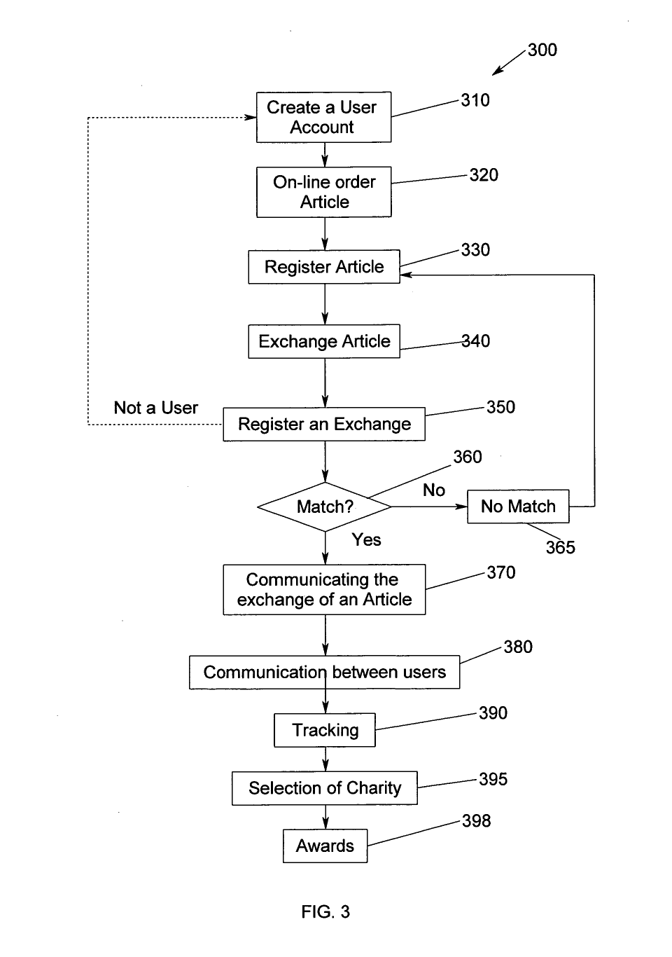

Referring now to FIG. 3, there is illustrated a preferred flow diagram in which user 302, user 303 and server 304 of communication system 200 interact according to communication method 300 within the communication system 200 of FIG. 2. Users 302 and 303 preferably have attributes comparable to those described above with respect to user system 220, 222. Users 302, 303 are referred to hereafter as users of communication system 200 and/or member based on the system, methods and/or processes described herein. Server 304 preferably has attributes comparable to those described above with respect to server system 260. Server 304 is referred to hereafter as database and communication source implemented by communication system 200 and based on the system, methods and/or processes described herein. Server 304 is preferably interconnected to user 302 and 303 through a known or described delivery network. The network preferably has attributes comparable to those described above with respect to network 250. Communication method 300 preferably can be implemented by communication system 200 or other similar hardware, software, device, computer, computer system, equipment, component, application, code, storage medium, or propagated signal.

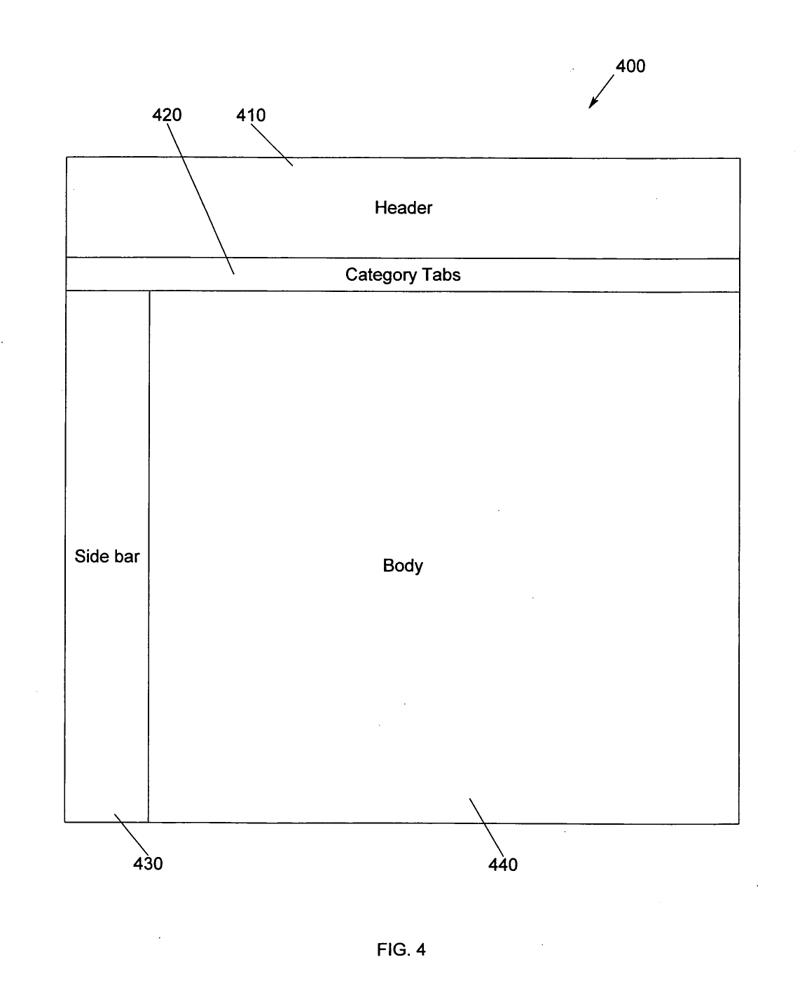

As illustrated in FIG. 3, preferred communication method 300 starts with step 310 wherein users 302 and 303 preferably sends to server 304 a request to enroll, to become a member/user and/or to create a member/user profile (step 310). Server 304 preferably receives the instruction that user 302/303 has requested to become a member/user and/or to create a member/user profile. In response, server 304 preferably sends user 302 at least one template 400 (see FIG. 4) for user 302/303 to use to guide user 302 through further steps set forth in FIG. 3. In step 310, user 302/303 preferably selects a unique user name and password, and user 302/303 may provide additional information such as home address, city, state, zip code, country, telephone number, email address, history, background, statement, payment information and the like (“user information 12”) to be stored by server 304 as a record of user 302. User 302/303 preferably designates each piece of User Information as either private or public information.

Referring to FIG. 4, template 400 preferably is general user interface (GUI) computer screens such as website pages and the like having text, graphics, text entry windows, drop down selection windows, radial buttons, clickable buttons and the like. Moreover, User 302/303 preferably can personalize or customize template 400 designated as user 302/303 landing page with text, graphics, pictures, audio files, video files and the like. Website pages are readily known in the art and are not discussed in further detail in this application, so as not to overcomplicate the present discussion. Moreover, website pages are stored in database 270 and are delivered to user 302 via server 304.

According to FIG. 3, in step 320 of communication method 300, user 302 preferably purchases an article 10 such as a bracelet via server 304 e-commerce applications. Preferably, such article 10 is made up of individual links wherein such links have a detachable components and each such detachable component preferably has a unique identifier affixed thereto that functions to identify such detachable component. Alternatively, article 10 may include the entire jewelry piece, a part of the jewelry piece or a subpart of the jewelry piece and wherein such component or piece is designed to be exchanged. Server 304 preferably generates a unique identifier such as a serial number for each detachable component and stores such identifier in database 270; however, other identifiers are contemplated herein such as bar code labels, unique product codes, RFID tags, holograms, micro-label, micro-engraving, laser inscription, optical codes, digital codes and the like which may be used to track, identify, and authenticate articles exchanged in trade.

User 302 preferably selects an inscription to be engraved on the detachable component from a set of predetermined inscriptions in a drop down menu or enters text of such inscription into a text box and such information preferably is stored by server 304 in database 270. Operator of server 304 preferably produces the ordered detachable component with generated serial number and inscription and ships the detachable component, base link, bracelet, known collectively as article 10, to user 302. The integration of an e-commerce application into server 304 enabling purchase of article 10 on-line is readily known in the art and is not discussed in further detail in this application, so as not to overcomplicate the present discussion. It should be understood that although electronic or Internet purchase of article 10 is preferred, other modes of purchase could be utilized, such as print catalog, telephone, physical storefront, or any other suitable means of purchase, and that other previously-owned articles could be substituted for preferred bracelet without departing from the spirit and intended scope of the present invention.

It is contemplated herein that the operator of communication method 300 manufactures or contracts for manufacture article 10, affixes its unique identifier, engraves or etches its inscription, and ships article 10 to user 302.

In step 330 of communication method 300, user 302 preferably receives the ordered article 10 via mail or other delivery system. Next, user 302 preferably logs into server 304 using the unique name and password previously enrolled, and registers the original ownership of each detachable component of article 10, wherein server 304 preferably stores, in database 270, the status of each unique identifier, its owner and its associated detachable component associated with article 10.

In step 340 of communication method 300, first original owner of article 10 user 302 preferably exchanges a detachable component from article 10 with a third party or other individual referred to herein as second owner of a detachable component from article 10 user 303 by physically exchanging the detachable component from one user 302 to the next user 303. Alternatively, user 302 may exchange article 10, a link in article 10, a piece of article 10, a component of article 10, a subcomponent of article 10 with a third party or other individual referred to herein as second owner. Article 10 preferably is designed to enable user 302/303 to disassemble and assemble the exchanged article 10 by releasing article retaining system described herein. Further, it is contemplated herein that user 302 could be a celebrity personality utilizing communication method 300. Still further, it is contemplated herein that user 302 could exchange, register, identify other articles utilizing communication method 300.

In step 350 of communication method 300, preferably second owner of a detachable component from article 10 user 303 logs into server 304 if user 303 is a valid enrolled user of server 304; however, if user 303 is not a valid enrolled user of server 304, then server 304 directs user 303 to step 310 of communication method 300 to create a user account. Next, user 303 selects to register an exchange with server 304 preferably by clicking a selectable option entitled “register a swap,” set forth in template 400. User 303 preferably enters the unique identifier and inscription found on the detachable component of article 10 received in the exchange.

In step 360 of communication method 300, server 304 preferably determines whether the unique identifier and inscription entered by user 303 corresponds to the inscription and identifier registered by first original owner of article 10 user 302 in database 270. If no match is identified between inscription and identifier for such article 10, then server 304 informs user 303 that the unique identifier and inscription entered does not match a record in database 270 (Step 365). Moreover, if a matching record is not found for article 10, then server 304 directs user 303 to initiate registration of the article 10 in step 330 of communication method 300.

If the unique identifier and inscription entered by user 303 for article 10 matches a record in server 304 then server 304 informs user 303 that the unique identifier and inscription entered by user 303 matches a record for article 10 stored in database 270 (Step 370). For example, server 304 preferably sends user 303 a statement, such as, “Congratulations, you have made a valid swap!” Furthermore, server 304 preferably communicates the public user information 12 of each previous registered user 302 from the original owner of article 10 and each subsequent owner of article 10 to user 303, including, for example, registered name, home city, ghost email, and the like of such previously registered users. Server 304 preferably maps the location, calculates distance traveled, time of possession and registered user 302/303 having possession of the detachable component from article 10 for user 303 of article 10 during its journey and communicates such public information 12 to user 303. Still further, server 304 preferably communicates the public user information 12 of user 303 to each user 302 who previously registered article 10, including, for example, registered name, home city, ghost email, and the like of such previously registered users. Server 304 preferably maps the location, calculates distance traveled, time of possession and registered user 302 for each registered user 302/303 of article 10 during its journey and communicates such information to user 302. Server 304 preferably stores all article 10 information and data regarding respective users 302/303 linked to the user 302, and linked to each user 303 registering article 10 after user 302; however, in general, other processes for indexing records, storing records and searching an indexed body of records is known in the art and may be utilized.

In step 370 of communication method 300, server 304 preferably enables user 302 to request, search or query for registered and/or unregistered article(s) 10, and/or registered user(s) 302 and server 304 communicates such user public information 12 and/or article 10 information to user 302.

In step 380 of communication method 300, server 304 preferably enables users 302 and 303 to communicate with each other by email, instant text messaging, voiceover IP telecommunications and the like, sharing their experience in exchanging article 10. Server 304 preferably enables users 302 and 303 to send anonymous communications to other users 302/303 and preferably enables users 302 and 303 to view a landing page of other users 302/303 public information and any tracking information related to exchanges of articles 10. Server 304 may be enabled to protect the identity and/or private user information 12 of user 302/303 during communication between users 302 and 303.

In step 390 of communication method 300, server 304 preferably tracks information regarding each article 10, including but not limited to monthly, annual, lifetime or other intervals of time between exchanges of article 10 between users 302 and 303 and maintains a counter of the number of times article 10 is exchanged between users 302 and 303. Furthermore, server 304 preferably tracks monthly, annual, lifetime or other intervals of time for distances traveled for each article 10. Still further, server 304 preferably tracks monthly, annual, lifetime or other intervals of time for the number of exchanges of articles 10 for each user 302. Still further, server 304 preferably tracks monthly, annual, lifetime or other intervals of time for distance traveled of a detachable component from article 10.

In step 395 of communication method 300, server 304 preferably provides user 302/303 with the option of selecting from a list of charitable organizations which user 302/303 would like to see supported. Server 304 stores such user 302/303 selection(s) of a charitable organization with user's 302/303 other data and information records and preferably enables users 302/303 to view such selection on user's 302/303 landing page. Server 304 preferably tracks monthly, annual or other intervals of time each charitable organization has been selected by user 302/303.

In step 398, server 304 preferably designates the top users 302 or 303 for the following categories, including but not limited to, users 302/303 with the most exchanges of a single article 10, users 302/303 with the most articles 10 exchanged, users 302/303 with the most exchanges of a detachable component from article 10, users 302/303 with the most detachable components from article 10 exchanged, user 302/303 in possession of most articles 10 over time, or a detachable component from article 10 traveling the greatest distance between registrations, quickest user 302/303 to obtain 100 exchanges or other designated milestone, and combinations of milestones such as users 302/303 with the greatest number of exchanges of articles 10 or detachable components from article 10 and users 302/303 with articles 10 or a detachable components from article 10 traveling the greatest distance between registrations whether monthly, annually or other designated interval of time. Server 304 preferably enables such designated users 302/303 to select a charitable organization such users 302/303 would like to see added to a list of charitable organizations being supported. Server 304 preferably enables such designated users 302/303 to cast vote(s) for selected charitable organization to be supported by a percentage of net revenues from sales and royalties from sales of article 10 and/or detachable components of article 10. In step 398, server 304 preferably tracks the top users 302/303 in each category set forth above and communicates such information to users 302/303 via a leader's board landing page. It is contemplated herein that other designations and criteria for top users 302/303 may be established.

It is contemplated herein that the operator of communication method 300 makes payment of the percentage of net revenues from sales and royalties from sales of article 10 and/or detachable components of article 10 to the selected charitable organization(s).

Referring now to FIG. 4, there is illustrated a preferred screen shot template 400 of a user interface enabling user 302/303 to communicate with server 304. Template 400 preferably is a graphical user interface generated by server 304 and communicated to user 302/303 having at least one field or window that enables user 302/303 to enter text and/or data in predefined fields, or a drop down window allowing user 302/303 to select from a set of predefined options, or radial button(s) that upon clicking such button, user 302/303 has selected a predefined option, or clickable button(s) enabling user 302/303 to make a selection. User 302/303 preferably enters text and/or data into template 400 populating the fields of template 400 with user information or other information requested by server 304.

User 302 preferably clicks on a button of template 400 sending user information 12 to server 304. Server 304 receives user information 12 or other information requested by server 304 and stores user information 12 and other information in database 270. Server 304 preferably searches or queries database 270 in response to a user 302/303 request for user information 12 or other information stored in database 270, and server 304 preferably communicates such information to user 302/303 via template 400. Template 400 is preferably generated using a common internet language such as HTML or XML. “Common internet language” as used herein means a computer programming language that is a standard or common programming language designed to facilitate communication between the different types of computers and operating systems found on the Internet, and specifically includes all versions of Java, HTML (hypertext markup language) and XML (extensible markup language) or any other webpage development language. The present invention also preferably includes program code to store a series of created WebPages with assigned page numbers, and to allow a user 302/303 to recall the pages in any desired order from server 304.

In general, WebPages are stored in Java, HTML or XML format in association with “server” software at server 304. A webpage, such as template 400, is given a “Uniform Resource Locator” (URL) which is essentially an address path identifying the server which hosts the desired document plus the location of the document on the server. Using “browser” software, an end-user can send a request from user 302/303 to access a webpage stored at a particular URL. Browser software such as INTERNET EXPLORER or NETSCAPE is well known and widely available. When server 304 receives user's 302/303 requests, it sends the requested HTML or XML webpage to user 302/303 where the document can be displayed. The communication protocol used in making such a request and in transferring WebPages is “Hypertext Transfer Protocol” (HTTP).

Template 400 preferably includes but is not limited to header 410, category tabs 420, side bar 430, and body 440 which organize the page into regions having text, graphics, text entry windows, tabs, hyper links, drop-down selection windows, radial buttons, clickable buttons and the like. Any suitable format may be utilized for expression of the information.

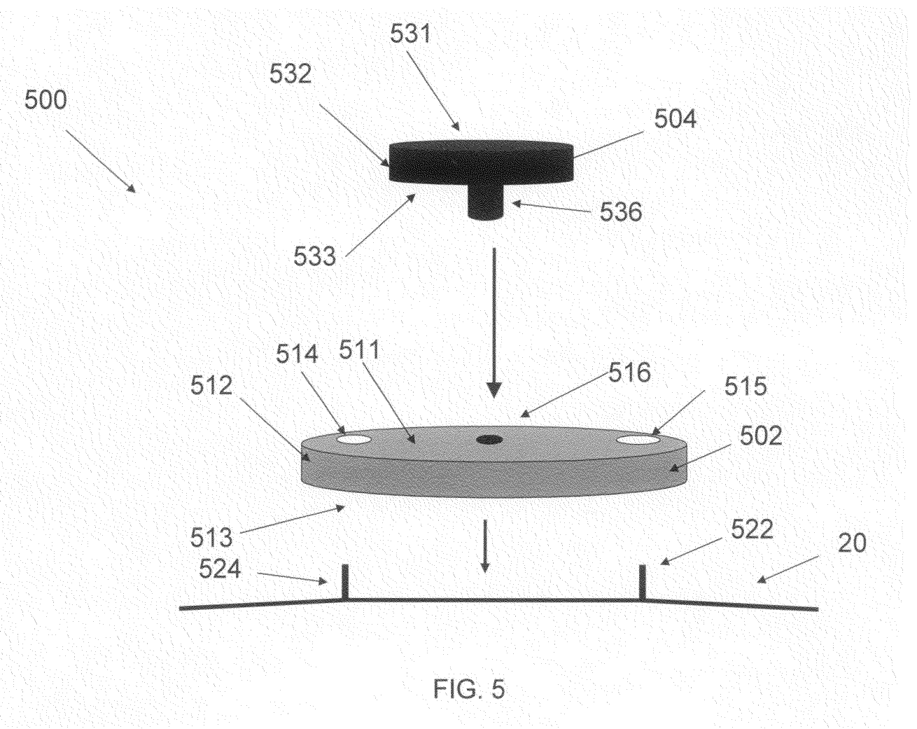

Referring now to FIG. 5, there is illustrated a preferred bracelet component 500. Bracelet component 500 preferably comprises base 502 and detachable member 504. Article 10 preferably is detachable member 504; however, article 10 may comprise base 502 and detachable member 504 as well as an entire collection of base 502 pieces making up a bracelet. It is contemplated in an alternate embodiment that article 10 could be a component of a ring, necklace, broche, pendant and the like or the entire jewelry piece, a part of the jewelry piece or a subpart of the jewelry piece and wherein such component or piece is designed to be exchanged.

Base 502 comprises sides 511, 512, and 513, preferably defining an oval shape; however, other shapes are contemplated herein such as circular, square, rectangle, triangle and the like. Base 502 preferably is formed of a suitable material, such as metal, precious metal such as silver, plastic, or the like, capable of providing structure to bracelet component 500. Preferably, the material includes other suitable characteristics, such as durability, ability to engrave or etch, water-resistance, light weight, chemical inertness, oxidation resistance, ease of workability, or other beneficial characteristic understood by one skilled in the art. Base 502 of bracelet component 500 preferably includes an article retaining system, such as threaded female hole 516, capable of releaseably retaining detachable member 504 to base 502, in a desired position. It is contemplated herein that article retaining system may be a snap mechanism, compression fitting, swivel lock, latch, rivet, adhesive, hook and loop, clasps or other beneficial retaining system understood by one skilled in the art. Base 502 preferably includes holes 514 and 515, utilized to preferably affix bracelet component 500 to a link in a bracelet 20 or alternatively affixing two or more bases 502 together to form the bracelet 20. Preferably, bracelet 20 is silver half round band with male rivet posts 522 and 524 for inserting into holes 514 and 515 to affix base 502 to bracelet 20. It is contemplated that bracelet 20 could have multiple bases 502 affixed to bracelet 20. It is further contemplated herein that base 502 could be affixed to bracelet 20 by compression fitting, swivel lock, latch, adhesive, hook and loop, clasps or other beneficial affixing system understood by one skilled in the art.

Bracelet component 500 preferably includes detachable member 504. Detachable member 504 comprises similar sides 531, 532, and 533 as base 502, and detachable member 504 is preferably arranged in an oval shape with a T-configuration; however, other shapes are contemplated herein such as circular, square, rectangle, triangle and the like. Detachable member 504 preferably is formed of a suitable material, such as metal, precious metal such as silver, plastic or the like, capable of providing structure to detachable member 504 of bracelet component 500. Preferably, the material includes other suitable characteristics, such as durability, ability to engrave or etch, water-resistance, light weight, chemical inertness, oxidation resistance, ease of workability, or other beneficial characteristic understood by one skilled in the art. Detachable member 504 of bracelet component 500 preferably includes an article retaining system, such as threaded male member 536, capable of releaseably retaining detachable member 504 to base 502, in a desired position. It is contemplated herein that article retaining system may be a snap mechanism, compression fitting, swivel lock, latch, rivet, adhesive, hook and loop, clasps or other beneficial retaining system understood by one skilled in the art. Side 531 of detachable member 504 preferably includes an inscription that the original purchaser or user 302/303 selects to be engraved or etched on the surface of side 531 of detachable member 504. Furthermore, side 533 of detachable member 504 preferably includes a unique serial number inscribed on the surface of side 533.

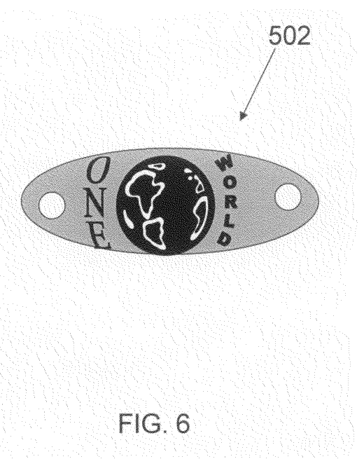

Referring now to FIG. 6, side 511 of base 502 preferably includes an inscription, such as “ONE WORLD” with a graphic of the earth either engraved or etched on the surface of side 511 visible to others that user 302/303 wearing bracelet component 500 is participating in the article 10 exchange and the ONE WORLD CONNECTS' (OWC) network. It is contemplated herein that other text, graphic or artistic expression could be engraved or etched on the surface of side 511. Alternatively, side 531 may be engraved or etched on the surface of side 531 of detachable member 504 preferably includes an inscription, such as “ONE WORLD” with a graphic of the earth either engraved or etched on the surface of side 531 visible to others that user 302/303 wearing bracelet component 500 is participating in the article 10 exchange and the ONE WORLD CONNECTS' (OWC) network.

Although the description given above includes specific examples of currently envisioned embodiments of the computer program, method, system, and/or apparatus, these possibilities should not be understood as limiting the scope of the present invention but rather as providing illustrations of some of the embodiments that are now preferred. Several examples of alternate embodiments are also described and various other alternatives, adaptations, and modifications may be made within the scope of the present invention. Merely listing or numbering the steps or blocks of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the claims that follow herein and their legal equivalents, rather than the examples given in the specification, should determine the scope of present.

What is claimed is:

1. A method of registering the ownership and exchange of an article, said method comprising:
creating a user account in an on-line website via the Internet;
registering a serial number of an article under said user account as an original user in possession of said article via the Internet;
exchanging said article from said original user to a third party user;
creating a third party user account in an on-line website via the Internet registering said serial number of said article under said third party user in possession of said article via the Internet;
tracking information of said users, said article and said exchange; and
displaying said information to said user via the Internet.

2. The method of claim 1, wherein said information is selected from a group consisting of owner name, password, address, city, state, zip code, country, telephone number, email address, history, background, statement, payment information, said articles current location, said article prior location, said articles route of travel, said articles distance traveled, said articles owner, and combinations thereof.

3. The method of claim 2, wherein said method further comprises the step of communicating said information to said user.

4. The method of claim 1, wherein said information is selected from a group consisting of said user whose said article traveled the greatest distance between said registrations, said user with the greatest number of said article exchanges, unique identifier, said serial number, and combinations thereof.

5. The method of claim 4, wherein said method further comprises the step of communicating said information to said user.

6. The method of claim 1, wherein said method further comprises programming code to enable communication between a server and said user via the Internet.

7. The method of claim 6, wherein said programming code is HTML.

8. The method of claim 6, wherein said programming code is XML.

9. The method of claim 1, wherein said method further comprises the step of verifying said original user and said third party user via a user name and password.

10. The method of claim 1, wherein said method further comprises the step of providing communication between said original user and said third party user, wherein each said users possessed said article.

11. The method of claim 1, wherein said method further comprises the step of awarding said owner of said article having traveled the greatest distance since origination a percentage of said article's proceeds by gifting said percentage of said article's proceeds to a charity selected by said user, via the Internet.

12. A system comprising:
a server connected to a network, said server receiving requests from users via said network, said server including:
at least one processor;
a database of user information; and
a memory operatively coupled to said processor, said memory containing stored programming instructions that instruct said processor to:
(a) create a user account;
(b) register a serial number of an article under said user account as an original user in possession of said article;
(c) create a third party user account;
(d) register said serial number of said article under said third party user in possession of said article due to an exchange of said article from said original user to a third party user;
(e) track information of said users, said article and said exchange; and
(f) display said information to said user.

13. The system of claim 12, wherein said information is selected from a group consisting of owner name, password, address, city, state, zip code, country, telephone number, email address, history, background, statement, payment information, said articles current location, said article prior location, said articles route of travel, said articles distance traveled, said articles owner, and combinations thereof.

14. The system of claim 13, wherein said system further communicates said information to said user.

15. The system of claim 12, wherein said information is selected from a group consisting of said user whose said article traveled the greatest distance between said registrations, said user with the greatest number of said article exchanges, unique identifier, said serial number, and combinations thereof.

16. The system of claim 15, wherein said system further communicates said information to said user.

17. The system of claim 12, wherein said programming instruction is HTML.

18. The system of claim 12, wherein said programming instruction is XML.

19. The system of claim 12, wherein said system further validates said original user and said third party user via a user name and password.

20. The system of claim 12, wherein said system provides communication between said original user and said third party user, wherein each said users possessed said article.

21. The method of claim 1, wherein said system awards said owner of said article having traveled the greatest distance since origination a percentage of said article's proceeds by gifting said percentage of said article's proceeds to a charity selected by said user.

22. A system for monitoring the exchange of articles comprising:
a computer processor; an input device; a display; and a memory accessible by the computer processor, the memory containing stored programming instructions that instruct the processor to:
(a) create a user account in an on-line website via the Internet;
(b) register a serial number of an article under said user account as an original user in possession of said article via the Internet;
(c) create a third party user account in an on-line website via the Internet;
(d) register said serial number of said article under said third party user in possession of said article due to an exchange of said article from said original user to a third party user; via the Internet;
(e) track information of said users, said article and said exchange; and
(f) display said information to said user via the Internet.
